(19) United States
(12) Patent Application Publication
(10) Pub. No.: US 2004/0166934 A1
(43) Pub. Date: Aug. 26, 2004

(54) Method of and apparatus for object interaction expression, and computer product

(75) Inventors: Katsuhiko Nakata, Kawasaki (JP); Yukari Sato, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/774,593

(22) Filed: Feb. 10, 2004

(30) Foreign Application Priority Data
Feb. 20, 2003 (JP) 2003-043100

(51) Int. Cl. A63F 13/00

(52) U.S. Cl. 463/30

(57) ABSTRACT

An object interaction expression apparatus for expressing interactions between plural objects that move by simulation in a virtual space is provided. The apparatus includes an expression mode storing unit, an interaction magnitude calculating unit and an expression controller. The expression mode storing unit stores in a correlated form an interaction magnitude of an object and a corresponding expression mode in which the interaction magnitude will be expressed. The interaction magnitude calculating unit calculates interaction magnitudes of objects that interact with each other. The expression controller controls an expression of the interaction magnitude of the objects that interact with each other based on the expression modes stored corresponding to the interaction magnitude calculated.

### BACKGROUND OF THE INVENTION

1) Field of the Invention

The present invention relates to an apparatus for expressing interaction between plural objects that move by simulation in a virtual space. More specifically, the present invention relates to an apparatus for expressing the magnitude of the interaction.

2) Description of the Related Art

Apparatuses for expressing interaction between plural objects that move by simulation in a virtual space have become widely known in recent years. Such apparatuses for object interaction expression determine whether or not there is overlapping of space where objects are present and display the conflicting area. For instance, Japanese Patent Laid-Open Publication No. H10-20918 discloses a technology whereby over-grinding or under-grinding is prevented by displaying the conflict between a product and a working tool in a CAD/CAM apparatus.

However, the expression model disclosed in the above literature merely indicates if a conflict exists between the product and the working tool but fails to accurately tell the user the amount of over-grinding or under-grinding.

### SUMMARY OF THE INVENTION

It is an object of the present invention to solve at least the problems in the conventional technology.

An apparatus according to one aspect of the present invention is an apparatus for expressing interactions between plural objects that move by simulation in a virtual space. This apparatus includes an expression mode storing unit that stores in a correlated form an interaction magnitude of an object and a corresponding expression mode in which the interaction magnitude will be expressed; an interaction magnitude calculating unit that calculates interaction magnitudes of objects that interact with each other; and an expression controller that controls an expression of the interaction magnitude of the objects that interact with each other based on the expression mode stored corresponding to the interaction magnitude calculated.

A method for expressing interactions between plural objects that move by simulation in a virtual space according to another aspect of the present invention includes storing in a correlated form an interaction magnitude of an object and a corresponding expression mode in which the interaction magnitude will be expressed; calculating interaction magnitudes of objects that interact with each other; and controlling an expression of the interaction magnitude of the objects that interact with each other based on the expression mode stored corresponding to the interaction magnitude calculated.

A computer program according to still another aspect of the present invention makes a computer execute the method according to the present invention.

The other objects, features, and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of an apparatus for object interaction expression according to a first embodiment of the present invention;

FIG. 2A and FIG. 2B are examples of interaction magnitudes and expression modes stored in the expression mode storing unit illustrated in FIG. 1;

FIG. 3 illustrates an example of the post-collision impact waveform;

FIG. 4 illustrates an example of the post-collision impact wave animation;

FIG. 5 illustrates an example of the post-collision change of colors;

FIG. 6 illustrates an example of the post-collision impact sound;

FIG. 7 illustrates an example of the post-collision vibration;

FIG. 8 is a flow chart of the sequence of steps executed by the apparatus for object interaction expression shown in FIG. 1;

FIG. 9 is a block diagram of a computer system according to a second embodiment of the present invention; and

FIG. 10 is a block diagram of the main unit of the computer system shown in FIG. 9.

### DETAILED DESCRIPTION

Exemplary embodiments of a method of, an apparatus for, and a computer program for object interaction expression according to the present invention will be explained next with reference to the accompanying drawings. Expression of object interaction in the case when plural deformable bodies collide with each other and the resultant deformation of the deformable bodies is an elastic deformation will be explained as a first embodiment. A computer system that executes the program for object interaction expression according to the present invention will be explained as a second embodiment. Finally, deformations in the case of collision between a deformable body and a plastic body, between two plastic bodies, etc. when the resultant deformation is a plastic deformation will be explained.

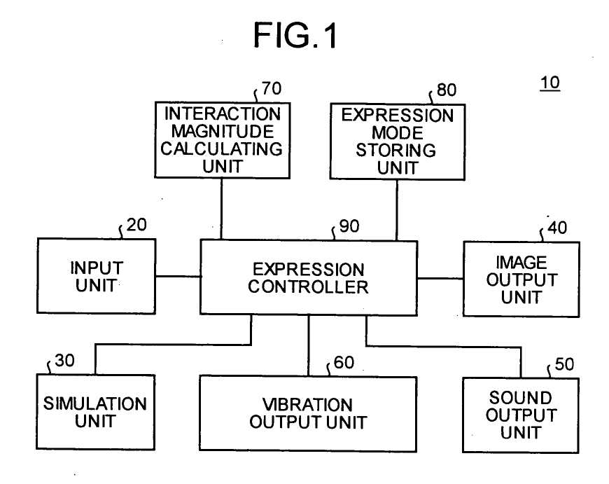

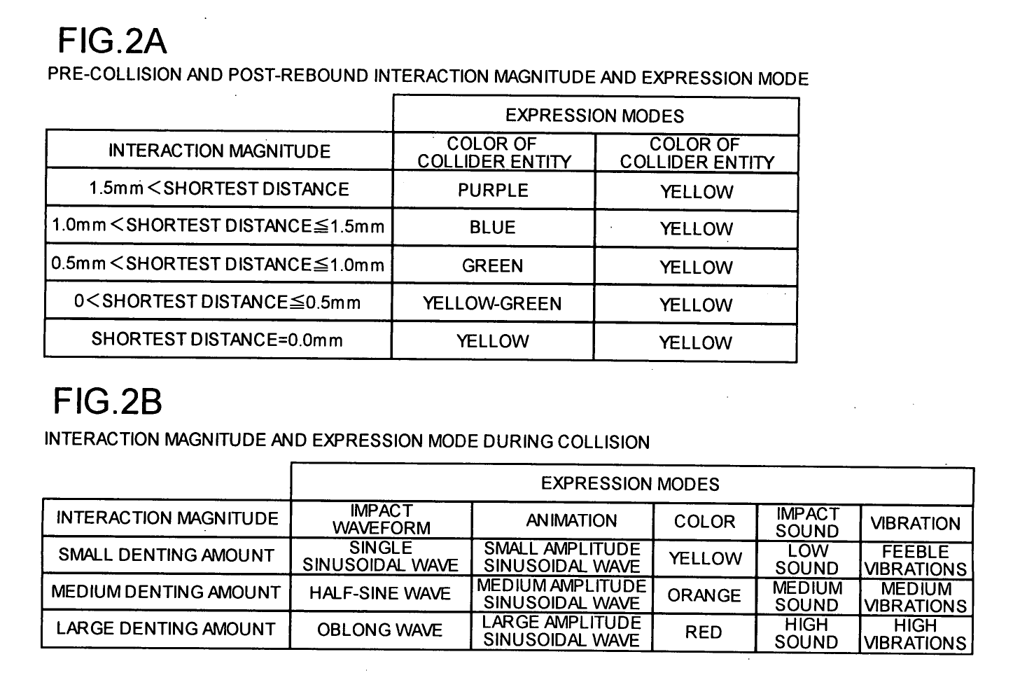

First, an overview and the main features of the apparatus for object interaction expression according to the first embodiment will be explained. FIG. 1 is a block diagram of the apparatus for object interaction expression according to the first embodiment. FIG. 2A and FIG. 2B illustrate examples of interaction magnitudes and expression modes stored in the expression mode storing unit illustrated in FIG. 1.

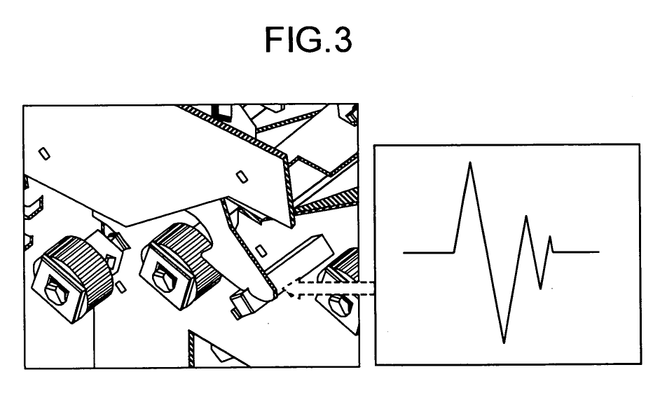

In FIG. 1, the reference numeral 10 represents the apparatus for expressing the interaction between plural objects that move by simulation in a virtual space. To be more specific, the apparatus 10 for objection interaction expression includes an expression mode storing unit 80, an interaction magnitude calculating unit 70, and an expression controller 90. The expression mode storing unit 80 stores in correlated form the interaction magnitude of each of the plural objects and the expression mode of each magnitude (see FIG. 2A and FIG. 2B). The interaction magnitude calculating unit 70 calculates the interaction magnitude of the plural objects that move by simulation. The expression controller 90 controls the expression of interaction magnitude using the expression mode that corresponds to the calculated interaction magnitude (see FIG. 3 through FIG. 7). Thus, the user can discern an extent to which the various objects are approaching each other, or are bumping into each other, or are moving away from each other.

As shown in FIG. 1, the apparatus 10 for object interaction expression comprises an input unit 20, a simulation unit 30, an image output unit 40, a sound output unit 50, a vibration output unit 60, the interaction magnitude calculating unit 70, the expression mode storing unit 80, and the expression controller 90.

The input unit 20 can be a keyboard, a touch pen, a mouse, and the like and is a means for inputting data such as coordinates of the object in the virtual space, properties, state quantity, etc. that is required for the creation of a simulation model, a simulation condition, a user request or specification, etc.

The simulation unit 30 creates the simulation model based on data such as the coordinates of the object in the virtual space, the properties, the state quantity, etc. input from the input unit 20 and, using the simulation model, realizes the analysis simulation such as motion analysis of the objects, collision deformation analysis of the objects, and the like.

Motion analysis simulation involves placing a reference frame on the center of gravity of an object and observing plural objects. The object on which the reference frame is placed is called a collidee entity and the other objects are called collider entities. In other words, the simulation unit 30 simulates a process wherein the collider entities move based on the equation of motion, friction or the force of gravity, etc. and approach the collidee entity, collide with it and rebound. When the collider entity collides with the collidee entity, the simulation unit 30 further simulates a collision deformation analysis based on the impact, and determines a relative distance between the center of gravity of the collidee entity and the center of gravity of the collider entity after the elastic deformation.

The interaction magnitude calculating unit 70 calculates the interaction magnitude of the objects. The simulation unit 30 determines a relative distance between the center of gravity of the collidee entity and the center of gravity of the collider entity. Before the plural objects collide, the interaction magnitude calculating unit 70 calculates, based on the relative distance, the shortest distance between a point on the surface of the collidee entity and a point on the surface of the collider entity. When the plural objects collide with each other, the interaction magnitude calculating unit 70 calculates a denting amount, based on the relative distance after the elastic deformation. After the plural objects collide and rebound, the interaction magnitude calculating unit 70 calculates, based on the relative distance, the shortest distance between a point on the surface of the collidee entity and a point on the surface of the collider entity.

The image output unit 40 can be a CRT or an LCD. The result of the analysis simulation carried out by the simulation unit 30 is output onto the image output unit 40 in the form of an image. To be more specific, the image output unit 40 displays the objects simulated by the motion analysis simulation as still images or as animation. The animation can be made slower or faster than realtime, as required.

The sound output unit 50 outputs an impact sound in synchronization with the result of the analysis simulation, and includes at least a sound-producing circuit and a speaker. To be more specific, when two objects collide as per the motion analysis simulation, the sound output unit 50 outputs the impact sound in accordance with the material or the interaction magnitude of the collider entities. For instance, the sound output unit 50 stores in a storage unit, the impact sound data of collision of two objects made of the same material, carries out digital-to-analog conversion of the data, and plays the sound on the speaker.

The vibration output unit 60 outputs vibrations in synchronization with the result of the analysis simulation, and includes at least a vibration-producing circuit and a vibration-producing motor. Specifically, when the plural objects collide as per the motion analysis simulation, the vibration output unit 60 drives the vibration-producing motor installed within the mouse and outputs vibrations having strength in accordance with the material or the interaction magnitude of the collider entities. For instance, the vibration output unit 60 stores in a storage unit, the vibration data of collision of two objects made of the same material, carries out digital-to-analog conversion of the data, and reproduces the vibration on the vibration-producing motor.

The expression mode storing unit 80 stores in a correlated form each interaction magnitude and an expression mode. To be more specific, the expression mode storing unit 80 stores each interaction magnitude by correlating it with a visual expression mode, an aural expression mode and/or a tactile expression mode.

For instance, the expression mode storing unit 80 stores the pre-collision and post-rebound interaction magnitudes by correlating them with different colors, and the interaction magnitudes during collision by correlating them with one or more of impact waveforms, impact wave animations, impact sounds, and vibrations.

The expression controller 90 controls the entire apparatus 10 for object interaction expression in such a way that the image output unit 40, the sound output unit 50, and the vibration output unit 60 express the respective interaction magnitude using the expression mode corresponding to the interaction magnitude calculated by the interaction magnitude calculating unit 70 from among the expression modes stored in the expression mode storing unit 80

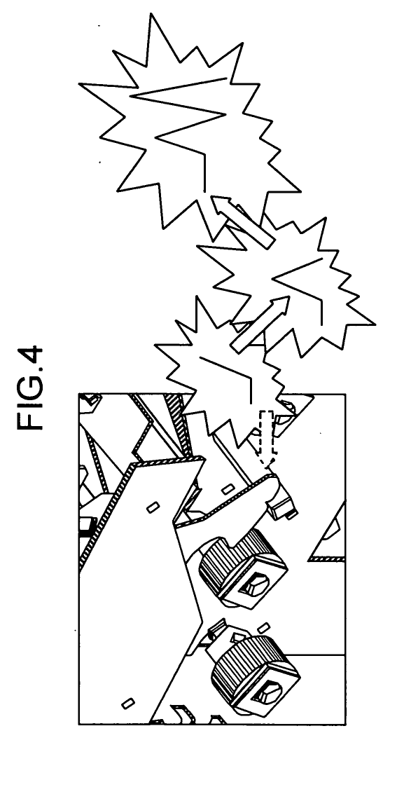

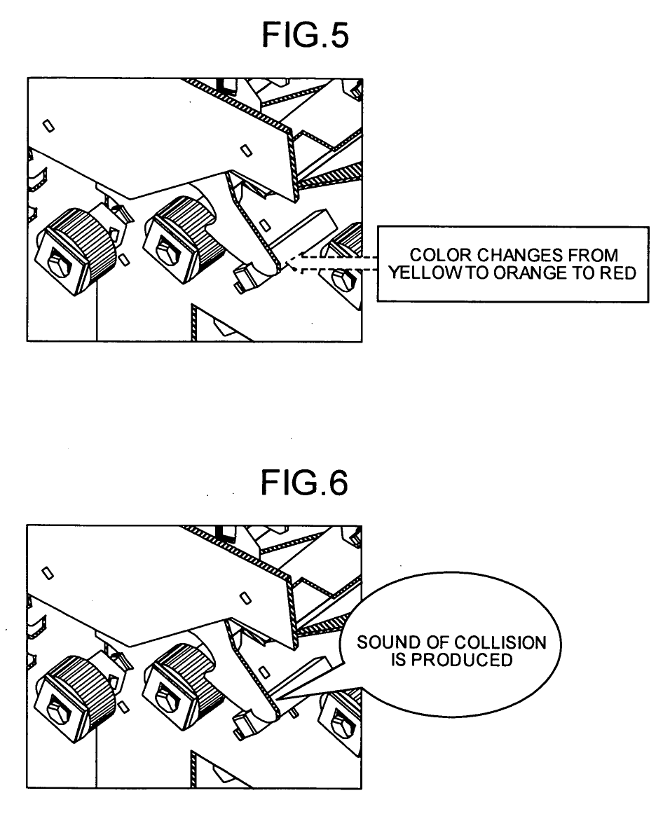

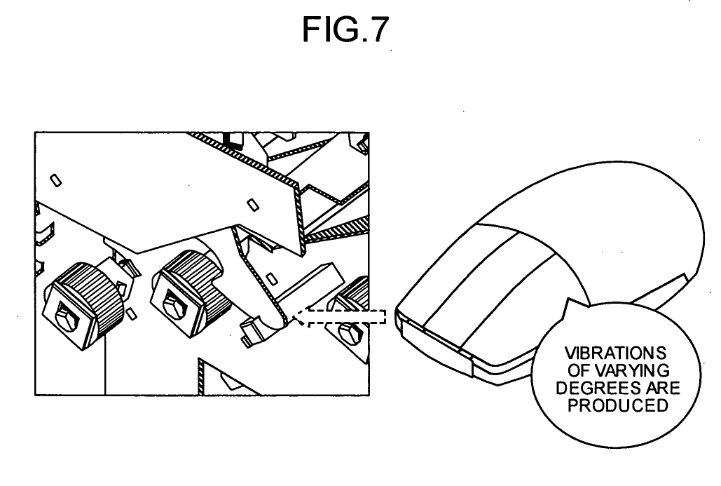

Examples of the interaction magnitudes and the expression modes stored in the expression mode storing unit 80 shown in FIG. 1 will be explained next. FIG. 3 illustrates an example of post-collision impact waveform. FIG. 4 illustrates an example of post-collision impact waveform animation. FIG. 5 illustrates representation of post-collision impact by change of colors. FIG. 6 illustrates post-collision impact sound. FIG. 7 illustrates post-collision vibration.

As shown in FIG. 2A, the pre-collision and post-rebound interaction magnitude of plural objects is the shortest distance between a point on the surface of the collider entity and a point on the surface of the collidee entity. The expression mode storing unit 80 stores each of these shortest distances by correlating it with a color for the collider entity and the collidee entity. Consequently, when the collider entity and the collidee entity are more than 1.5 mm apart, the expression controller 90 makes the image output unit 40 display the collider entity in purple and the collidee entity in yellow as the collider entity and the collidee entity approach each other.

To be more specific, the expression controller 90 controls the expression in such a way that when the distance between the collider entity and the collidee entity when the former is approaching the latter is 1.5 mm, 1.0 mm, and 0.5 mm the color of the collider entity changes from blue to green to yellowish green. When the collider entity touches the collidee entity, the collider entity turns yellow. When after collision the collider entity rebounds from the collidee entity, the color of the collider entity changes from yellow to yellowish green to green to blue to purple as the distance between the two objects changes from 0 mm to 0.5 mm to 1.0 mm to 1.5 mm to more than 1.5 mm.

The interaction magnitude is also expressed in terms of denting amount to indicate the extent to which the collider entity has dented the collidee entity. The denting amount depends on the properties of the objects and the impact of the collision. In general, in the elastic deformation region, when the impact of the collision is small, it is represented by a single sinusoidal wave, when the impact is medium it is represented by a half-sine wave, and when the impact is large, it is represented by an oblong wave.

In other words, the expression mode storing unit 80 stores a single oblong wave correlated with the large denting amount corresponding to a large impact, a single half-sine wave correlated with the medium denting amount corresponding to a medium impact, and a single sinusoidal wave correlated with the small denting amount corresponding to a small impact. Thus, the expression controller 90 makes the image output unit 40 display an oblong wave, a half-sine wave or a sinusoidal wave in accordance with the denting amount (see FIG. 3).

In this way, the designer or developer of the product can discern the impact waveforms that are produced by the magnitude of the impact. Thus, the expression of the magnitude of the impact in this form enables the designer or developer to viscerally appreciate the magnitude of the impact. This facilitates efficient designing and developing of the product.

Another means of controlling the expression is by expressing the impact of the collision as an impact wave animation on the image output unit 40 (see FIG. 4). In this case, the expression mode storing unit 80 stores the interaction magnitudes by correlating them with a large magnitude sinusoidal wave, a medium magnitude sinusoidal wave, and a small magnitude sinusoidal wave. In addition, the expression controller 90 also controls the expression in such a way that apart from animation, another visual expression mode in the form of color representation also indicates the magnitude of the impact (see FIG. 5). In this case, the expression mode storing unit 80 stores the interaction magnitudes correlating them with the colors yellow, orange, and red in such a way that the color of the collider entity and the collidee entity changes according to the magnitude of the impact.

Further, the expression controller 90 controls the expression in such a way that the sound output unit 50 and the vibration output unit 60 output the impact of the collision by means of an aural expression mode and a tactile expression mode, respectively (see FIG. 6 and FIG. 7). In these cases, the expression mode storing unit 80 stores the interaction magnitudes correlating them with actual sounds and vibrations of collision for large, medium, and small impacts of collision.

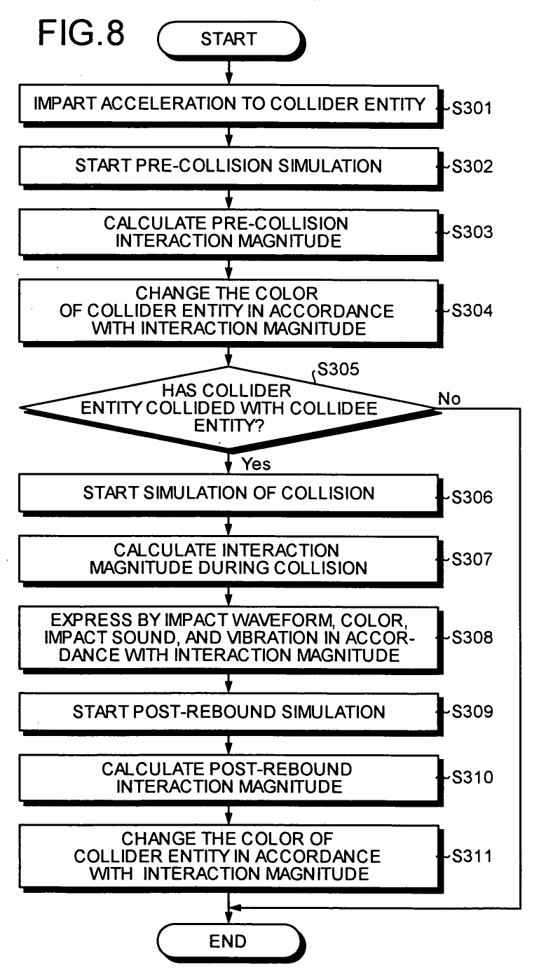

The process executed by the apparatus 10 for object interaction expression shown in FIG. 1 will be explained next. FIG. 8 is a flow chart of the sequence of steps executed by the apparatus 10 for object interaction expression.

First, the simulation unit 30 imparts acceleration to the collider entity and starts the pre-collision motion analysis simulation (steps S301 and S302). At this time the color of the collider entity is purple and that of the collidee entity is yellow. The simulation unit 30 determines the relative distance between the center of gravity of the collider entity and the center of gravity of the collidee entity. The interaction magnitude calculating unit 70 calculates, based on the relative distance, the shortest distance between a point on the surface of the collider entity and a point on the surface of the collidee entity (step S303). The expression controller 90 controls the expression such that the color of the collider entity changes in accordance with the shortest distance (step S304).

To be more specific, the expression controller 90 controls the expression in such a way that the color of the collider entity changes from purple to blue to green to yellowish green as the distance between the collider entity and the collidee entity changes from 1.5 mm to 1.0 mm, to 0.5 mm, respectively. When the collider entity touches the collidee entity, the expression controller 90 displays the collider entity in the same color as the collidee entity, that is, yellow.

Next, the expression controller 90 checks if the collider entity has collided with the collidee entity (step S305). If the expression controller 90 detects that the collider entity has not collided with the collidee entity, the expression controller does not change the color of the collider entity (‘No’ at step S305).

If the collider entity collides with the collidee entity (‘Yes’ at step S305), the simulation unit 30 commences the collision deformation analysis simulation. The simulation unit 30 determines the relative distance between the center of gravity of the collider entity and the center of gravity of the collidee entity after the elastic deformation. The interaction magnitude calculating unit 70 calculates the denting amount based on the relative distance (step S307). The expression controller 90 controls the expression in accordance with the denting amount in such a way that the magnitude of the impact of the collision is expressed by changing colors (visual), or by impact sound (aural) or by vibrations (tactile) (step S308).

More specifically, when the denting amount is small, the expression controller 90 controls the expression in such a way that the image output unit 40 displays a single sinusoidal wave, and the color of both the collider entity and the collidee entity as yellow, the sound output unit 50 produces a low sound, and the vibration output unit 60 produces feeble vibrations. When the denting amount is medium, the expression controller 90 controls the expression in such a way that the image output unit 40 displays a half-sine wave, and the color of both the collider entity and the collidee entity as orange, the sound output unit 50 produces a medium sound, and the vibration output unit 60 produces medium vibrations. When the denting amount is large, the expression controller 90 controls the expression in such a way that the image output unit 40 displays an oblong wave, and the color of both the collider entity and the collidee entity as red, the sound output unit 50 produces a loud sound, and the vibration output unit 60 produces high vibrations.

Once the collision of the objects is over, the simulation unit 30 commences the post-rebound motion analysis simulation (step S309). The interaction magnitude calculating unit 70 calculates the shortest distance (step S310). The expression controller 90 controls the expression in such a way that the color of the collider entity changes in accordance with the shortest distance (step S311).

To be more specific, the expression controller controls the expression in such a way that the color of the collider entity changes from yellow to yellowing green to green to blue to purple as the post-rebound distance between the collider entity and the collidee entity increases from 0 mm to 0.5 mm to 1.0 mm to 1.5 mm to beyond 1.5 mm.

To sum up, the expression mode storing unit 80 stores each interaction magnitude of the plural objects by correlating the interaction magnitude with an expression mode (see FIG. 2). The interaction magnitude calculating unit 70 calculates the interaction magnitude of the plural objects that move by simulation. The expression controller 90 controls the expression in such a way that the interaction magnitude calculated is expressed by means of the corresponding expression mode (see FIG. 3 through FIG. 7). Therefore, the user can discern the extent to which the various objects are approaching each other, or are bumping into each other, or are moving away from each other.

The apparatus for and method of object interaction expression described above can be realized by executing a pre-set program on a personal computer or a computer system such as a workstation. Such a computer system is explained next.

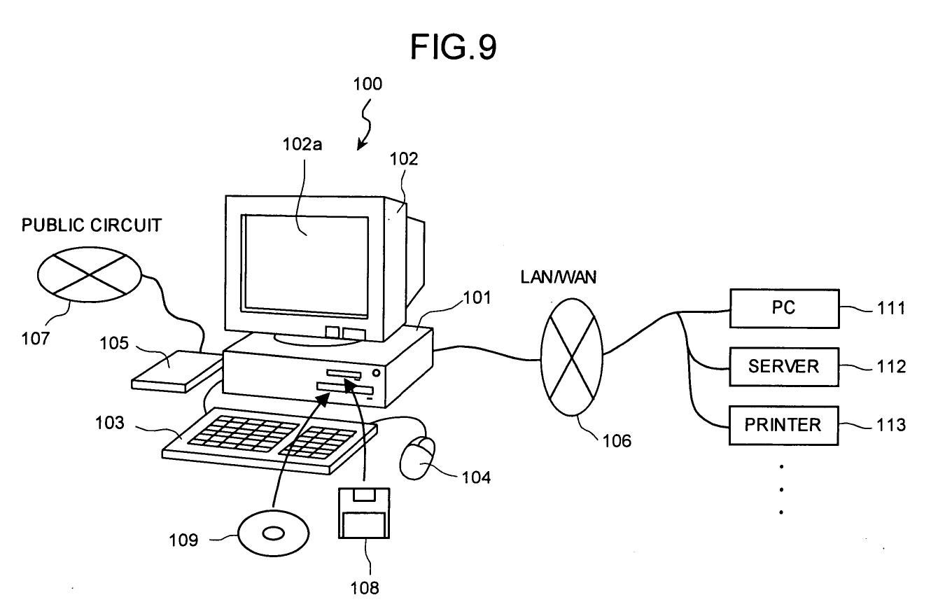

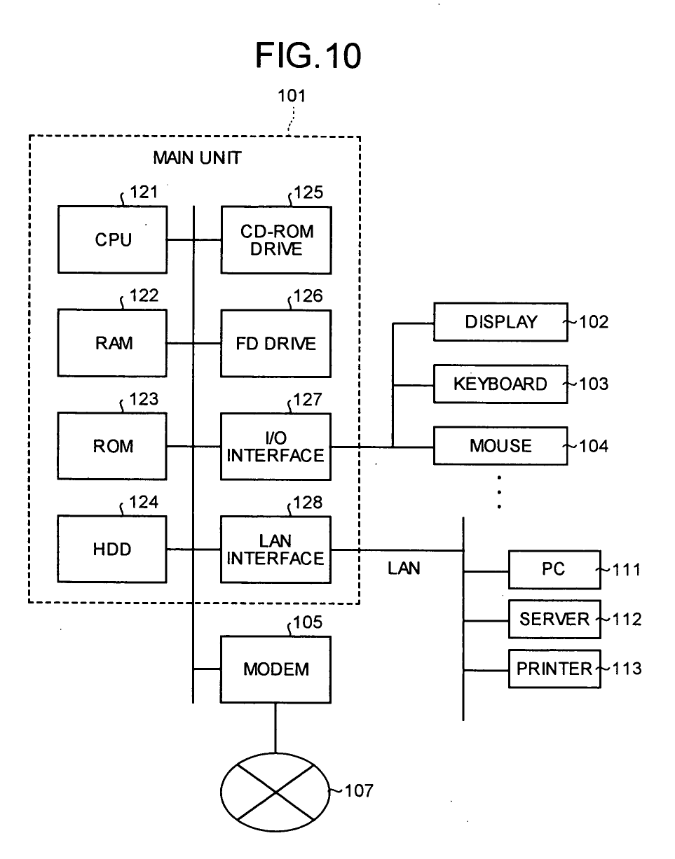

FIG. 9 is a block diagram of a computer system according to a second embodiment of the present invention. FIG. 10 is a block diagram of the main unit of the computer system shown in FIG. 9. As shown in FIG. 9, a computer system 100 according to the second embodiment includes a main unit 101, a display unit 102 that displays data such as images on a display screen 102a based on instructions from the main unit 101, a keyboard 103 using which various data can be input into the computer system 100, and a mouse 104 using which any point on the display screen 102a of the display unit 102 can be specified.

As shown in FIG. 10, the main unit 101 of the computer system 100 includes a central processing unit 121, a random access memory (RAM) 122, a read-only memory (ROM) 123, a hard disk drive (HDD) 124, a CD-ROM drive 125 that accepts a CD-ROM 109, a flexible disk (FD) drive 126 that accepts a flexible disk 108, an I/O interface that connects the keyboard 103 and the mouse 104, and a LAN interface 128 that connects to a local area network or a wide area network (LAN/WAN) 106.

A modem 105 is used to connect the computer system 100 to a public circuit 107 such as the Internet, as well as another computer system (PC) 111, a server 112, and a printer 113 through the LAN interface 128 and LAN/WAN 106.

The computer system 100 is able to function as an apparatus for object interaction expression by executing the program for object interaction expression stored in a predetermined storage medium. The storage medium may be a storage medium from which the computer system 100 can read the program for object interaction expression. For instance, the storage medium may be a ‘portable’ type in the form of flexible disk (FD) 108, CD-ROM 109, MO disk, DVD disk, magneto optic disk, IC card, etc., or a ‘fixed’ type in the form of hard disk drive (HDD) 124 integral to the computer system 100, RAM 122, ROM 123, etc, or a ‘communication medium’ in the form of public circuit 107 connected through the modem 105 or LAN/WAN 106 through which the computer system 100 is connected to another computer system 111 and the server 112, and which stores the transmitted program for a short duration.

In other words, the program for object interaction expression is stored in the ‘portable’ medium, ‘fixed’ medium or ‘communication medium’ described above in a readable manner, and the computer system 100 realizes the apparatus and method for object interaction expression by reading the program stored in the storage medium. Apart from the computer system 100, another computer system 111 or the server 112 can also execute the program for object interaction expression.

The first and the second embodiments of the present invention were described above. However, the present invention may also be applied in the form of different embodiments that fairly fall within the basic teaching herein set forth.

For instance, the expression mode is not limited to that illustrated in FIG. 2. The shortest distance and the color can be correlated as per the requirement. The interaction magnitude can be expressed not only visually by colors but also by a combination of aural and tactile expression modes. For example, as the various objects approach each other, not only is there a visual indication by changing colors, but there is also aural and tactile indication in the form of a sound and vibrations.

Further, in the first embodiment, the expression of interaction magnitude in the case of elastic deformation when plural objects collide was explained. However, the deformation may also be in the plastic region and an expression corresponding to the interaction magnitude for plastic deformation can also be realized. Besides, it is also possible to express the interaction magnitude in the case when, the collision takes place between an elastic object and a plastic object. It is possible to express the interaction magnitude in the case in which two plastic objects collide and merge into one.

In the first embodiment, plural objects undergoing elastic deformation was explained. However, apart from this, when the temperature difference between the plural objects is large, the interaction magnitude of the plural objects can be expressed by taking into consideration the temperature difference by correlating them with visual, aural or tactile expressions modes. For instance, when a collider entity that is at a lower temperature approaches a collidee entity that is at a higher temperature, the rising temperature of the collider entity can be shown by means of change of color.

All the automatic processes explained in the present embodiment can be entirely or in part carried out manually. Similarly, all the manual processes explained in the present embodiment can be entirely or in part carried out automatically. The sequence of processes, the sequence of controls, specific names, information including various data or parameters (for instance in FIG. 2) can be changed as required unless otherwise specified.

The constituent elements of the apparatuses illustrated are merely conceptual and may not necessarily physically resemble the structures shown in the drawings. For instance, the apparatus for object interaction expression need not necessarily have the structure that is illustrated. The apparatus as a whole or in parts can be broken down or integrated either functionally or physically in accordance with the load or how the apparatus is to be used. The process functions of the apparatuses can be wholly or partially realized by the CPU or a program run by the CPU or can be realized by hardware through wired logic.

The object interaction expression apparatus according to the present invention has a structure in which the interaction magnitude of the plural objects moving by simulation in the virtual space is stored in correlation with the expression mode in which the interaction magnitude will be expressed, the interaction magnitude of the objects that interact with each other is calculated and the interaction magnitude of the objects that interact with each other based on the expression mode stored corresponding to the interaction magnitude calculated. Consequently, the user can easily discern the interaction magnitudes of the objects.

Moreover, the interaction magnitude is calculated from the distance between the objects. Consequently, the user can discern the interaction magnitudes of the objects from the distance between the objects.

Furthermore, the interaction between the objects is collision, and the interaction magnitude is calculated from the distance between the objects after an elastic deformation of the objects. Consequently, the user can discern the interaction magnitudes of the objects from the distance between the plural objects after the elastic deformation.

Moreover, the expression modes are stored in the form of correlated visual, aural, and/or tactile expression modes. Consequently, the user can discern the interaction magnitudes through multiple sensory inputs.

Furthermore, the object interaction expression apparatus has a structure in which pre-collision and post-collision interaction magnitudes are stored by correlating them with the expression mode expressed by changing colors, and the interaction magnitudes during collision are stored by correlating them with expression modes expressed by one or more of an impact waveform, impact wave animation, color, impact sound, and vibrations. Consequently, the user can viscerally discern the interaction magnitude of the multiple objects, before, during, and after collision.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An object interaction expression apparatus for expressing interactions between plural objects that move by simulation in a virtual space, comprising:
an expression mode storing unit that stores in a correlated form an interaction magnitude of an object and a corresponding expression mode in which the interaction magnitude will be expressed;
an interaction magnitude calculating unit that calculates interaction magnitudes of objects that interact with each other; and
an expression controller that controls an expression of the interaction magnitude of the objects that interact with each other based on the expression mode stored corresponding to the interaction magnitude calculated.

2. The object interaction expression apparatus according to claim 1, wherein the interaction magnitude calculating unit calculates the interaction magnitude from a distance between the objects.

3. The object interaction expression apparatus according to claim 2, wherein the interaction between the objects is collision, and the interaction magnitude calculating unit calculates the interaction magnitude from the distance between the objects after an elastic deformation of the objects.

4. The object interaction expression apparatus according to claim 2, wherein the interaction between the objects is collision, and the interaction magnitude calculating unit calculates the interaction magnitude from the distance between the objects after a plastic deformation of the objects.

5. The object interaction expression apparatus according to claim 1, wherein the interaction between the objects is collision, and the interaction magnitude calculating unit calculates the interaction magnitude in terms of a denting amount.

6. The object interaction expression apparatus according to claim 1, wherein the expression mode storing unit stores as correlated expression modes visual mode, and one or both of aural and tactile expression modes.

7. The object interaction expression apparatus according to claim 4, wherein the interaction between the objects is collision, and the expression mode storing unit stores pre-collision and post-collision interaction magnitudes by correlating the interaction magnitudes with the expression mode expressed by changing colors, and the interaction magnitudes during collision by correlating the interaction magnitudes with the expression modes expressed by one or more of impact waveform, impact wave animation, color, impact sound, and vibrations.

8. The object interaction expression apparatus according to claim 1, wherein the objects are constituent elements of a product, and the expression modes that express the interaction magnitude constitute modes comprehensible by a designer of the product.

9. A method for expressing interactions between plural objects that move by simulation in a virtual space, comprising the steps of:
storing in a correlated form an interaction magnitude of an object and a corresponding expression mode in which the interaction magnitude will be expressed;
calculating interaction magnitudes of objects that interact with each other; and
controlling an expression of the interaction magnitude of the objects that interact with each other based on the expression mode stored corresponding to the interaction magnitude calculated.

10. The method according to claim 9, wherein the calculating includes calculating the interaction magnitude from a distance between the objects.

11. The method according to claim 10, wherein the interaction between the objects is collision, and the calculating includes calculating the interaction magnitude from the distance between the objects after an elastic deformation of the objects.

12. The method according to claim 9, wherein the storing includes storing as correlated expression modes visual mode, and one or both of aural and tactile expression modes.

13. The method according to claim 12, wherein the interaction between the objects is collision, and the storing includes storing pre-collision and post-collision interaction magnitudes by correlating the interaction magnitudes with the expression mode expressed by changing colors, and the interaction magnitudes during collision by correlating the interaction magnitudes with the expression modes expressed by one or more of impact waveform, impact wave animation, color, impact sound, and vibrations.

14. A computer program that makes a computer execute:
storing in a correlated form an interaction magnitude of an object and a corresponding expression mode in which the interaction magnitude will be expressed;
calculating interaction magnitudes of objects that interact with each other; and
controlling an expression of the interaction magnitude of the objects that interact with each other based on the expression mode stored corresponding to the interaction magnitude calculated.

15. The computer program according to claim 14, wherein the calculating includes calculating the interaction magnitude from a distance between the objects.

16. The computer program according to claim 15, wherein the interaction between the objects is collision, and the calculating includes calculating the interaction magnitude from the distance between the objects after an elastic deformation of the objects.

17. The computer program according to claim 14, wherein the storing includes storing as correlated expression modes visual mode, and one or both of aural and tactile expression modes.

18. The computer program according to claim 17, wherein the interaction between the objects is collision, and the storing includes storing pre-collision and post-collision interaction magnitudes by correlating the interaction magnitudes with the expression mode expressed by changing colors, and the interaction magnitudes during collision by correlating the interaction magnitudes with the expression modes expressed by one or more of impact waveform, impact wave animation, color, impact sound, and vibrations.
